(19) United States
(12) Patent Application Publication
(10) Pub. No.: US 2014/0093622 A1
(43) Pub. Date: Apr. 3, 2014

(54) READY TO EAT DEEP FRIED VEGETABLES AS APPETIZER AND SNACK

(71) Applicant: Alice Chang, South Pasadena, CA (US)

(72) Inventor: Alice Chang, South Pasadena, CA (US)

(21) Appl. No.: 13/864,146

(22) Filed: Apr. 16, 2013

Related U.S. Application Data
(60) Provisional application No. 61/708,179, filed on Oct. 1, 2012.

(51) Int. Cl. A23L 1/212

(52) U.S. Cl. CPC A23L 1/212
USPC 426/102; 426/615; 426/634; 426/637

(57) ABSTRACT

Deep fried, seasoned, and ready to eat vegetables in small pieces to be served conveniently as an appetizer and/or snack food. The comestible produced provides people who eat at fast food restaurants the choice of deep fried vegetables as appetizers, and people shopping for food the convenience of getting processed vegetables as snack food.

### CROSS-REFERENCE TO RELATED APPLICATION

The present application is related to and claims priority from prior provisional application Ser. No. 61/708,179, filed Oct. 1, 2012 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of comestibles and more specifically relates to ready to eat deep fried vegetables as appetizer and snack food.

2. Description of the Related Art

A vegetable is an edible plant or part of a plant, but usually excludes seeds and most sweet fruit. This typically means the leaf, stem, or root of a plant. Vegetables are typically high in nutritional value, including carbohydrates, vitamins, minerals, and antioxidants; much of which the human body needs to maintain good health. A lot of vegetables are hard in texture and require time for preparation and cooking, thus may be overlooked for eating. Some vegetables can be consumed raw, some may be eaten cooked, and some must be cooked in order to be edible. Vegetables needing to be cooked are most often cooked in savory or salty dishes; however much of the nutritional content of vegetables may be lost when preparing in traditional ways. A few vegetables can be used in desserts and other sweet dishes, such as pumpkin pie and carrot cake; however these forms are not typically eaten with regularity to affect diets of individuals. It is desirable that vegetables maintain a regular part of a person's diet; as such a convenient and tasty means for preparing them is desirable. A more efficient option is needed to provide vegetables for user consumption on a regular basis.

Various attempts have been made to solve the above-mentioned problems such as those found in U.S. Pat. and Pub. Nos. U.S. Pat. No. 4,272,553; 2008/0181995; U.S. Pat. No. 4,919,953; 2008/0138479; U.S. Pat. Nos. 7,709,043; 6,514,554; and 2010/0215826. This art is representative of deep fried comestibles. None of the above inventions and patents, taken either singly or in combination, is seen to describe the invention as claimed.

Ideally, a ready to eat deep fried vegetables edible as an appetizer and/or snack food should provide a nutritional vegetable comestible that is convenient to prepare and desirable to eat and, yet would be able to be processed and manufactured at a modest expense. Thus, a need exists for a reliable ready to eat deep fried vegetables edible as an appetizer and/or snack food to avoid the above-mentioned problems.

### BRIEF SUMMARY OF THE INVENTION

In view of the foregoing disadvantages inherent in the known fried comestibles art, the present invention provides novel ready to eat deep fried vegetables as appetizer and snack food system. The general purpose of the present invention, which will be described subsequently in greater detail is to provide a nutritional vegetable comestible that is convenient to prepare and desirable to eat.

The purpose of the present invention is to create deep fried, seasoned, and ready to eat vegetables in small pieces to be served conveniently as an appetizer and/or snack food. The invention is to provide people who eat at fast food restaurants the choice of deep fried vegetables as appetizers, and people shopping for food the convenience of getting processed vegetables as snack food.

A ready to eat deep fried vegetables as appetizer and snack food system is disclosed herein comprising ingredients combined in proportions substantially including: vegetables; and seasonings; wherein vegetables are sliced into slices (of vegetables); wherein vegetables (when raw) and seasoning are combined. The ready to eat deep fried vegetables as appetizer and snack food are able to be prepared by intermixing the seasonings with the vegetables, and when prepared are deep fried. The vegetables when deep fried are still relatively high in nutrition, including carbohydrates, vitamins, minerals, and antioxidants suitable for readily consuming.

A method of preparing the ready to eat deep fried vegetables as appetizer(s) and snack food(s) is also disclosed herein comprising the steps of: removing the vegetables from soil; washing the vegetables; peeling an outer layer of the vegetables (when necessary); cutting the vegetables into small pieces of varying shapes and sizes; and deep frying the vegetables in cooking oils. The method may further comprising the step of packaging the vegetables, as prepared into air tight containers to preserve freshness as a snack food to be eaten at a later date or sold.

The present invention holds significant improvements and serves as ready to eat deep fried vegetables as appetizer and snack food system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, ready to eat deep fried vegetables as appetizer and snack food, constructed and operative according to the teachings of the present invention.

FIG. 1 shows a perspective view illustrating vegetables for use as ready to eat deep fried vegetables as appetizer and snack food (once prepared to be eaten) according to an embodiment of the present invention.

FIG. 2 is a perspective view illustrating various vegetables for use (to be prepared) as ready to eat deep fried vegetables as an appetizer and/or a snack food according to an embodiment of the present invention of FIG. 1.

FIG. 3 is a flowchart illustrating a method of preparing ready to eat deep fried vegetables as an appetizer and/or a snack food according to an embodiment of the present invention of FIGS. 1-2.

The various embodiments of the present invention will hereinafter be described in conjunction with the appended drawings, wherein like designations denote like elements.

### DETAILED DESCRIPTION

As discussed above, embodiments of the present invention relate to comestibles and more particularly to ready to eat deep fried vegetables as appetizer and snack food as used to improve the convenience of including the eating of vegetables in an individual's diet and thus the overall health of the consumer.

Generally speaking, the purpose, as previously mentioned, is to create deep fried, seasoned, and ready to eat vegetables in small pieces to be served as appetizer and snack food. The vegetables may include root vegetables, fruit vegetables, flower buds, stem shoots, bulbs, legumes, and other types of vegetables. The root vegetables are starchy and may include for example, but are not limited to taro, carrot, turnip, yam, shallot, parsnip, potato, rutabaga, burdock, garlic, onion, radish, sweet potato, lotus root, beet root, parsley root, and the like.

The fruit vegetables may include cucumber, squash, zucchini, pumpkin, eggplant, pepper, tomato, avocado, and the like. The flower buds may include broccoli, cauliflower, and the like. The stem shoots may include asparagus, bamboo shoot, etc. The bulbs may include onion, garlic, shallot, and the like. The legumes may include green bean, lentil, snow pea, soybean, etc. and other types of vegetables include mushroom, brussels sprout, rhubarb, bean, pea, and the like. Upon reading this specification, it should be appreciated that, under appropriate circumstances, considering such issues as user preferences, design preference, structural requirements, marketing preferences, cost, available materials, technological advances, etc., other choices of vegetables and combinations thereof such as, for example, may be virtually infinite, however the vegetables presented herein may be sufficient to be enabling and is not meant to be limiting the scope of the present invention.

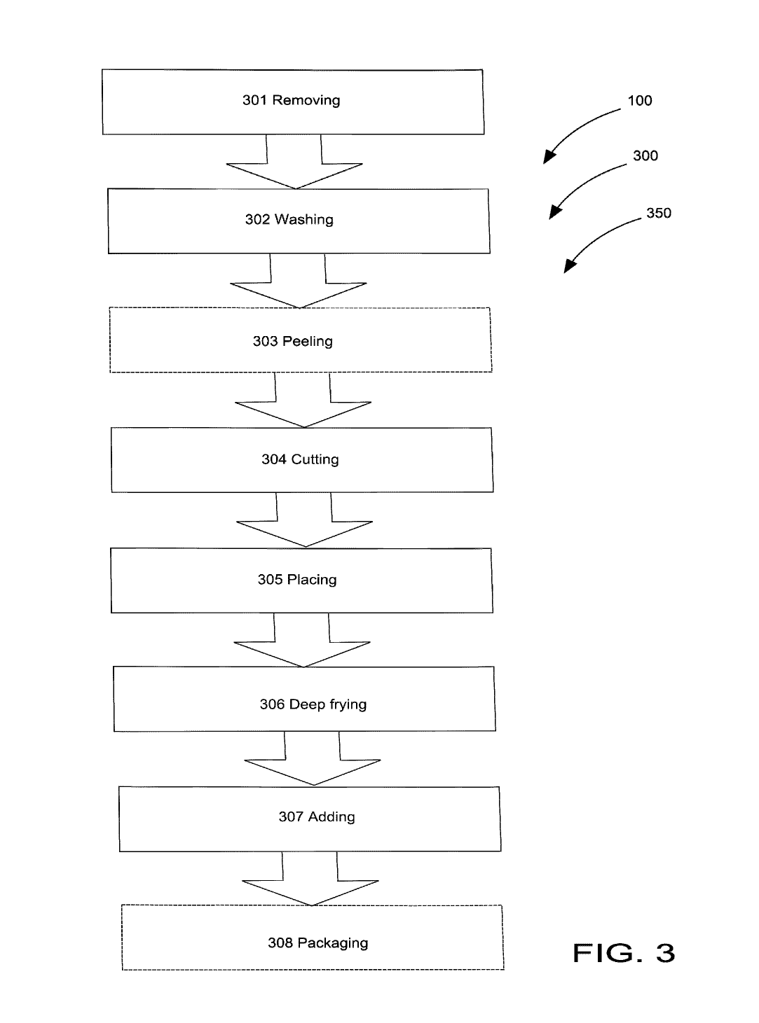

Making of the ready to eat deep fried vegetables as appetizer and snack food, as discussed in further detail in FIG. 3, includes: removing the vegetables from the soil; washing the vegetables; peeling an outer layer of the vegetables when necessary; and cutting the vegetables into small pieces of varying shapes and sizes. An example of the varying shape and size of the vegetables includes cubical shapes with each side about 1 to 2 inches in length, to be served as appetizer or snack food. Another example of the varying shape and size of the vegetables is wedges with a length of about 3 to 4 inches, to be served as appetizer or snack food. Another example of the varying shape and size of the vegetables is thin slices or chips to be packaged as snack food. Many different shapes may be used and will be considered to fall within the scope of the present invention.

The vegetables are preferably deep fried in cooking oils, such as corn oil, canola oil, sunflower oil, peanut oil, olive oil, coconut oil, sesame oil, grape seed oil, flaxseed oil, soybean oil, pumpkin seed oil, safflower oil, argan oil, rice bran oil, palm oil, palm kernel oil, etc. The seasonings and flavorings can be added and mixed into the cooking oils before deep frying and they can also be added and mixed into the vegetables after deep frying. The seasonings and flavorings can include salt, pepper, onion, garlic, ginger, curry, chili, vinegar, lemon, lime, peppermint, basil, thyme, parsley, rosemary, soup stock and broth, etc. Other seasonings used may include clove, cinnamon coriander, cumin, and shallots.

It should be noted that the deep fried and seasoned vegetables in small pieces do not require an outer layer in preferred embodiments to achieve maximum nutritional value. Further, if an outer layer is desired, bread crumbs or batter, such as beer batter, egg batter, or cornmeal batter, can be added. The deep fried and seasoned vegetables can be served at fast food restaurants as an appetizer or side dish. By creating ready to eat deep fried vegetables as appetizer and snack food, people can consume processed vegetables conveniently. The vegetables are also a new choice of snack food. Additionally, the ready to eat deep fried vegetables as appetizer and snack food are high in nutrition, including carbohydrates, vitamins, minerals, and antioxidants.

The ready to eat deep fried vegetables as appetizer and snack food can be packaged into air tight containers to preserve freshness and served as snack food. The containers can be made of paper, plastic, glass, metal.

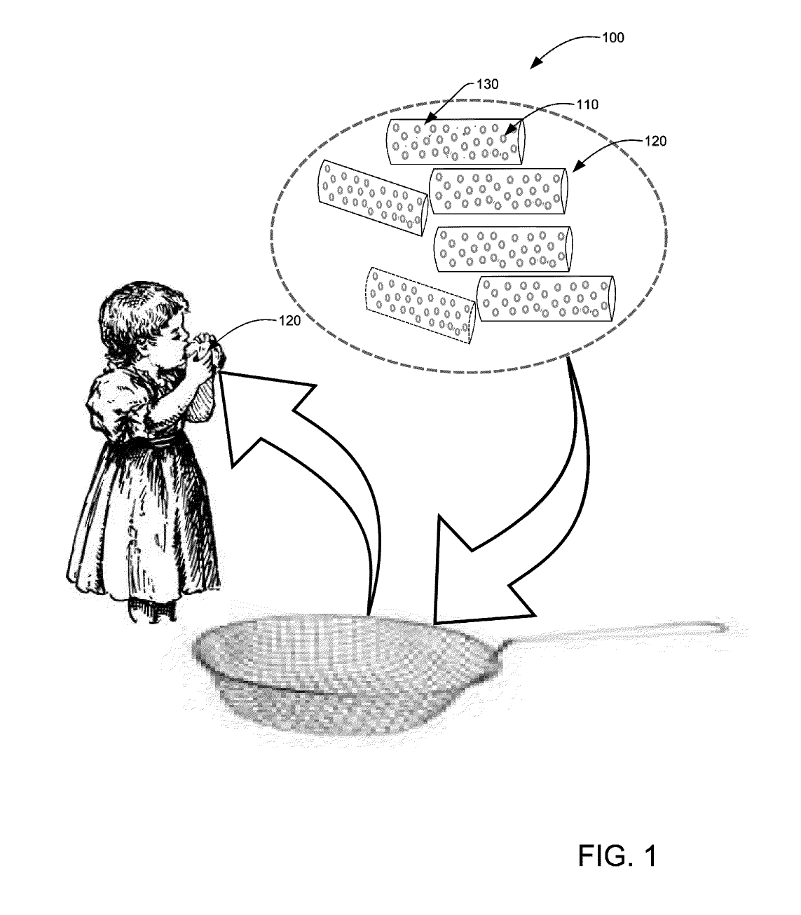

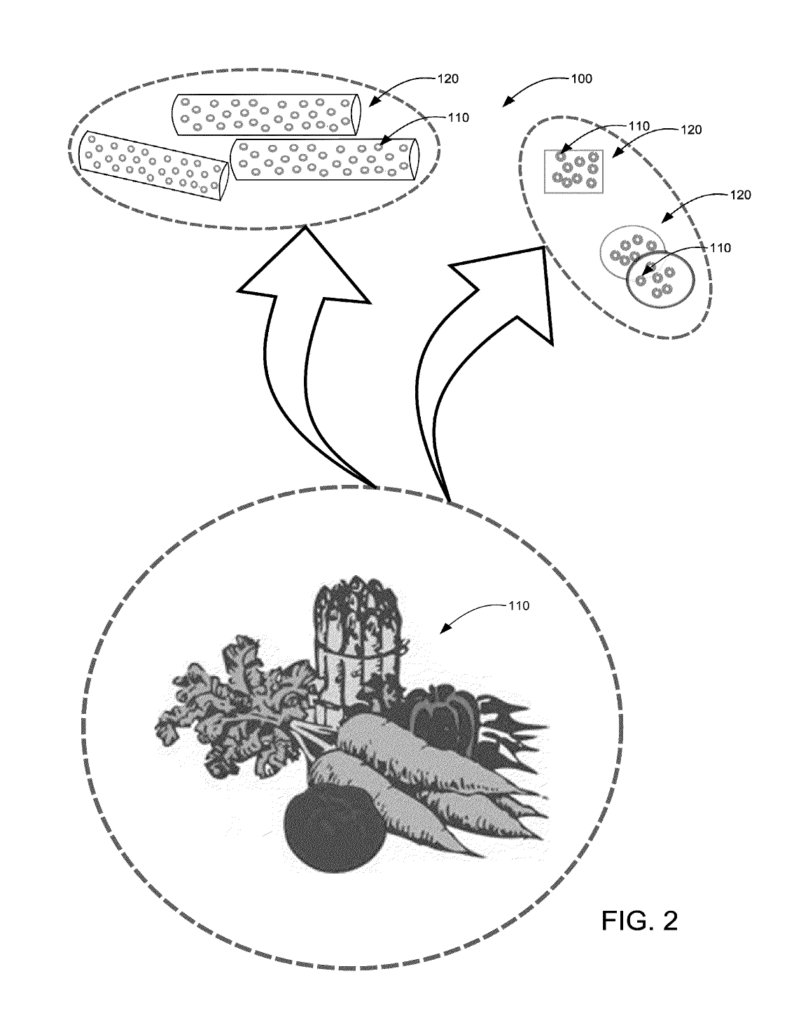

Referring to the drawings by numerals of reference there is shown in FIGS. 1-2 showing perspective views illustrating vegetables 110 for use as ready to eat deep fried vegetables 120 as appetizer and snack food (once prepared to be eaten) in FIG. 1 and in FIG. 2, to be prepared both according to an embodiment of the present invention.

Ready to eat deep fried vegetables 120 as appetizer and snack food system 100 comprises ingredients combined in proportions substantially including: vegetables 110; and seasonings 130. Vegetables 110 are sliced into slices (of vegetables 110); vegetables 110 and seasoning 130 are combined (preferably after cooking, but may be prior to cooking); wherein ready to eat deep fried vegetables 120 as appetizer and snack food (appetizer and snack food system 100) are prepared by intermixing seasonings 130 with vegetables 110, when prepared are deep fried, vegetables 110 when deep fried are still high in nutrition, including carbohydrates, vitamins, minerals, and antioxidants suitable for readily consuming.

Vegetables 110 preferably comprise no outer coating in ready to eat deep fried vegetables 120 as appetizer and snack food system 100 in preferred embodiments. In alternate embodiments vegetables 120 may comprise an outer coating; however this version is less preferred nutritionally. In embodiments using a coating seasonings and/or spices may be incorporated therein.

Vegetables 120 may comprise flower buds. Vegetables 120 may comprise stem shoots; bulbs; legumes; root-vegetables; fruit-vegetables in various alternate embodiments or combinations may be had thereof. Slices of vegetables 120 may comprise wedges; cubical shapes; disks or the like.

Ready to eat deep fried vegetables 120 as appetizer and snack food system 100 may comprise flower buds which are selected from the group consisting of broccoli, and cauliflower. Ready to eat deep fried vegetables 120 as appetizer and snack food system 100 may comprise bulbs which are selected from the group consisting of onion, garlic, and shallot. Additionally, ready to eat deep fried vegetables 120 as appetizer and snack food system 100 may comprise legumes which are selected from the group consisting of green bean, lentil, snow pea, and soybean. Further, ready to eat deep fried vegetables 120 as appetizer and snack food system 100 may comprise vegetables which are selected from the group consisting of mushroom, brussels sprout, rhubarb, bean, and pea.

Ready to eat deep fried vegetables 120 as appetizer and snack food system 100 may comprise root vegetables which are selected from the group consisting of taro, carrot, turnip, yam, shallot, parsnip, potato, rutabaga, burdock, garlic, onion, radish, sweet potato, lotus root, beet root, and parsley root, some of which are shown in FIG. 2. Ready to eat deep fried vegetables 120 as appetizer and snack food system 100 may comprise fruit vegetables which are selected from the group consisting of cucumber, squash, zucchini, pumpkin, eggplant, pepper, tomato, and avocado. Many other vegetables and combinations thereof may be envisioned to be used and still be considered within the scope of the present invention.

Referring now to FIG. 3, a flowchart 350 illustrating a method of preparing 300 ready to eat deep fried vegetables 120 as an appetizer and/or a snack food according to an embodiment of the present invention of FIGS. 1-2.

A method of preparing 300 ready to eat deep fried vegetables 120 as appetizer and snack food comprises the steps of: step one 301 removing vegetables from soil; step two 302 washing the vegetables; step three 303 peeling an outer layer of the vegetables when necessary; step four 304 cutting the vegetables into small pieces of varying shapes and sizes; step five 305 placing an outer layer to the vegetables if needed; step six 306 deep frying the vegetables in cooking oils; and step seven 307 adding seasonings and flavorings. The method may further comprising the step eight 308 of packaging the vegetables, as prepared into air tight containers to preserve freshness as a snack food.

It should be noted that steps three 303 and six 306 are optional steps and may not be implemented in all cases. Optional steps of method 300 are illustrated using dotted lines in FIG. 3 so as to distinguish them from the other steps of method 300.

It should be noted that the steps described in the method of use can be carried out in many different orders according to user preference. The use of “step of” should not be interpreted as “step for”, in the claims herein and is not intended to invoke the provisions of 35 U.S.C. §112, ¶ 6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A ready to eat deep fried vegetables as appetizer and snack food system comprising ingredients combined in proportions substantially including:
vegetables;
cooking oils; and
seasonings;
wherein said vegetables are sliced into slices of said vegetables;
wherein said vegetables and said seasonings are combined;
wherein said ready to eat deep fried vegetables as appetizer and snack food are prepared by intermixing said seasonings with said vegetables and said cooking oils, when prepared are deep fried, said vegetables when deep fried are high in nutrition, including carbohydrates, vitamins, minerals, and antioxidants suitable for readily consuming.

2. The ready to eat deep fried vegetables as appetizer and snack food system of claim 1 wherein said vegetables comprise no outer coating.

3. The ready to eat deep fried vegetables as appetizer and snack food system of claim 1 wherein said vegetables comprise an outer coating.

4. The ready to eat deep fried vegetables as appetizer and snack food system of claim 1 wherein said vegetables comprise flower buds, stem shoots, bulbs, legumes, root-vegetables, and fruit-vegetables.

5. The ready to eat deep fried vegetables as appetizer and snack food system of claim 1 wherein said slices of said vegetables comprise wedges.

6. The ready to eat deep fried vegetables as appetizer and snack food system of claim 1 wherein said slices of said vegetables comprise cubical shapes.

7. The ready to eat deep fried vegetables as appetizer and snack food system of claim 1 wherein said slices of said vegetables comprise disks.

8. The ready to eat deep fried vegetables as appetizer and snack food system of claim 4 wherein said flower buds are selected from the group consisting of broccoli, and cauliflower.

9. The ready to eat deep fried vegetables as appetizer and snack food system of claim 4 wherein said stem shoots are selected from the group consisting of asparagus and bamboo shoots.

10. The ready to eat deep fried vegetables as appetizer and snack food system of claim 4 wherein said bulbs are selected from the group consisting of onion, garlic, and shallot.

11. The ready to eat deep fried vegetables as appetizer and snack food system of claim 4 wherein said legumes are selected from the group consisting of green bean, lentil, snow pea, and soybean.

12. The ready to eat deep fried vegetables as appetizer and snack food system of claim 4 wherein said root vegetables are selected from the group consisting of taro, carrot, turnip, yam, shallot, parsnip, potato, rutabaga, burdock, garlic, onion, radish, sweet potato, lotus root, beet root, and parsley root.

13. The ready to eat deep fried vegetables as appetizer and snack food system of claim 4 wherein said fruit vegetables are selected from the group consisting of cucumber, squash, zucchini, pumpkin, eggplant, pepper, tomato, and avocado.

14. The ready to eat deep fried vegetables as appetizer and snack food system of claim 4 wherein said other vegetables are selected from the group consisting of mushroom, brussels sprout, rhubarb, bean, and pea.

15. The ready to eat deep fried vegetables as appetizer and snack food system of claim 1 wherein said cooking oils are selected from the group consisting of corn oil, canola oil, sunflower oil, peanut oil, olive oil, coconut oil, sesame oil, grape seed oil, flaxseed oil, soybean oil, pumpkin seed oil, safflower oil, argan oil, rice bran oil, palm oil, and palm kernel oil.

16. The ready to eat deep fried vegetables as appetizer and snack food system of claim 1 wherein said at least one seasoning is selected from the group consisting of salt, pepper, onion, garlic, ginger, curry, chili, vinegar, lemon, lime, peppermint, basil, thyme, parsley, rosemary, soup stock and broth, clove, cinnamon coriander, cumin, and shallots.

17. The ready to eat deep fried vegetables as appetizer and snack food system of claim 3 wherein said outer coating is selected from the group consisting of bread crumbs, beer batter, egg batter, and cornmeal batter.

18. The ready to eat deep fried vegetables as appetizer and snack food system of claim 1 wherein said cooked vegetables is storable in at least one air tight container.

19. A method of preparing ready to eat deep fried vegetables as appetizer and snack food comprising the steps of:
removing vegetables from soil;
washing the vegetables;
peeling an outer layer of the vegetables when necessary;
cutting the vegetables into small pieces of varying shapes and sizes;
placing an outer layer to the vegetables if needed;
deep frying the vegetables in cooking oils; and
adding seasonings and flavorings.

20. The method of claim 19 further comprising the step of packaging the vegetables, as prepared into air tight containers to preserve freshness as a snack food.
